(19) United States
(12) Patent Application Publication
(10) Pub. No.: US 2024/0219323 A1
(43) Pub. Date: Jul. 4, 2024

(54) X-RAY DETECTOR HAVING INCREASED RESOLUTION, ARRANGEMENT, AND CORRESPONDING METHODS

(71) Applicant: SMITHS DETECTION GERMANY GMBH, Wiesbaden (DE)

(72) Inventor: Philipp FISCHER, Wiesbaden (DE)

(21) Appl. No.: 18/265,592

(22) PCT Filed: Dec. 8, 2021
(86) PCT No.: PCT/EP2021/084805

§ 371 Date: Feb. 13, 2024

(30) Foreign Application Priority Data
Dec. 8, 2020 (DE) 102020132705.6

(51) Int. Cl. G01N 23/083; G21F 3/00

(52) U.S. Cl. CPC G01N 23/083; G21F 3/00; G01N 2223/04; G01N 2223/304; G01N 2223/32; G01N 2223/321; G01N 2223/33; G01N 2223/5015

(57) ABSTRACT

Disclosed is an arrangement of an X-ray detector and a shielding element shielding X-rays (RX) for increasing the spatial resolution of the X-ray detector, wherein the X-ray detector includes at least one detector line having at least one detector element arranged along the detector line, the shielding element including one or more regions opaque to X-rays (RX) and at least one region transparent to X-rays (RX), the shielding element arranged above the receiving surface for the X-rays (RX) of the at least one detector element, and the shielding element and the at least one detector element are movable relative to each other, so that the effective receiving surface for X-rays (RX) of the at least one detector element is correspondingly variable.

### CROSS-REFERENCE TO RELATED APPLICATIONS

The present application is a national stage entry of PCT/EP2021/084805 filed on Dec. 8, 2021, which claims the benefits of DE Patent Application No. 102020132705.6 filed on Dec. 8, 2020, the contents of which are hereby incorporated by reference in their entirety.

### BACKGROUND

The disclosure relates generally to an improvement in the sense of increasing the spatial resolution of an X-ray detector in the imaging non-destructive inspection of objects for finding target objects by means of X-ray radiography, and more particularly to an arrangement and a method for increasing the spatial resolution of an X-ray detector.

The following introductory background information to the present disclosure is provided solely for a better understanding of the context described below and represents prior art only to the extent of the contents of a said document publicly available at the time of filing.

It is known to scan an object to be inspected (inspection object) non-destructively line-by-line by means of electromagnetic beams emitted by a radiation source, wherein intensities of the beams not absorbed by the inspection object are detected by a detector arrangement associated with the radiation source and subsequently evaluated by means of known algorithms in a computer to generate an X-ray image of the object.

In X-ray inspection apparatuses in which an inspection object is transported at a predetermined transport speed through a scanning arrangement including a detector line arranged transversely to the transport direction and an X-ray fan directed towards the detector line, for a line-by-line scanning of the inspection object by the X-ray fan, the (physical) resolution of a generated X-ray image is essentially determined by the area of the individual detector elements each corresponding to an image point (pixel) and their number per unit of length or per unit of area of the detector line as well as the ratio of the transport speed of the inspection object in the transport direction and the read-out frequency of the detector elements.

Conventional X-ray inspection apparatuses have two-dimensional X-ray detectors with a spatial resolution limited by a pixel size in the range of 0.6 to 1.2 mm. For example, 800 pixels are arranged on a detector line; the detector line may include several sections, each formed by an associated detector unit. Small details of an X-ray image can only be perceived in a blurred manner due to the spatial size of the pixel. In particular, very fine structures, such as thin wires, can hardly be resolved and can therefore only be detected with difficulty.

In order to obtain a higher spatial resolution (in the sense of higher than the physical resolution of the detector) in the X-ray image generated transverse to the transport direction, the number of detector elements per unit of length or area could be increased accordingly. However, this leads to a corresponding increase in system cost for the detector as well as, since increasing the density of the detector elements requires a corresponding decrease in the area of each detector element, a degradation of the signal-to-noise ratio in the acquired detector data.

Independent of the spatial resolution transverse to the transport direction, the spatial resolution of the X-ray image in the scanning direction corresponding to the transport direction could be achieved by a reduced transport speed and/or an increased readout frequency. The former has a detrimental effect on the throughput of the inspection objects inspected at the X-ray inspection apparatus, and the latter again worsens the signal-to-noise ratio.

JP 2007-215929 A1 shows a medical X-ray apparatus with a movable Bucky grating above the detector. The Bucky grating is moved alternately in a first direction and in a second direction opposite to the first direction, ensuring that the position at which the speed of movement of the grating becomes zero, i.e. the reversal point of the movement, is always at a different position to avoid image distortions due to the grating in the position of the reversal point. An arrangement for the same purpose is shown in FR 2 869 789 A1, which also concerns a medical X-ray apparatus, wherein, in order to remove scattered X-rays with respect to the X-rays which, as desired, form the transmitted image on a detector, at least two Bucky discs including a circumferentially extending sequence of alternating sectors which are dense to X-rays and sectors which are transparent to X-rays and which are arranged coaxially with respect to the focal length of the X-rays, in the path of the X-rays between the X-ray source and a patient or, respectively, the X-ray table and the detector and are synchronously rotated about their axis.

US 2009/0285353 A shows an X-ray device called array CT scanning system for scanning objects with multiple X-ray fans. A conveyor belt is configured to transport baggage as inspection objects through a tunnel. Multiple X-ray sources are provided and configured to irradiate the tunnel with different X-ray compartments, each with detectors arranged to detect the fan beams. An image processing system is configured to generate 3D images of a scanned inspection object by interpolating the scan data in response to information received from the detectors. An operator can manipulate the image data and rotate the inspection object to detect objects therein.

### BRIEF DESCRIPTION

The embodiments described herein improve the spatial resolution of an X-ray detector in terms of increasing the resolution compared to the physical resolution of the X-ray detector without having to increase the number of detector elements of the detector per unit length or area.

For example, it would be an improvement for an X-ray detector (hereinafter referred to as “detector” for short) if, with a constant number of detector elements, an X-ray image with a higher spatial resolution in the image direction orthogonal to and/or along the scanning direction can be derived from the detector data acquired with the detector.

The above-mentioned improvements can be achieved with the features of the independent claim 1 concerning an arrangement for increasing the spatial resolution of an X-ray detector. Further embodiments and further developments are defined in the dependent claims.

The following statements should be preceded by the fact that even though the present disclosure and the individual embodiments explained in connection therewith always refer to X-rays, these are merely examples of electromagnetic or ionizing radiation; i.e., it is clear to the person skilled in the art that the principles presented here can also be applied to radiation other than X-rays.

The inventors have realized that a temporal change of the effective receiving area of a detector element for X-rays and a corresponding scanning (readout) of these respective receiving areas different from each other can be used advantageously for an improvement of the spatial resolution. The inventors have found out that the spatial resolution of the detector can thus be increased in the direction of the detector line and/or orthogonal to the detector line without increasing the total number of detector elements.

The core idea of the solution proposed here includes in the minimal implementation in an arrangement of a detector element and an associated shielding element, by means of which the effective receiving area of the detector element for X-rays can be changed by a temporally varying shadowing (e.g. by absorption or reflection) of the receiving area by the shielding element that is shielding X-rays (X-ray shielding shielding element). Thus the effective spatial resolution of the detector element can be increased. In particular, the shielding element is configured such that the effective receiving area of the detector element for incident X-rays can be changed thereby; the shielding element thus has the function of a dynamic aperture.

According to a first aspect, an arrangement including an X-ray detector and an X-ray shielding shielding element is provided for use in an X-ray inspection apparatus (for example, one according to the second aspect described below) configured to perform a method of X-ray radiography of an inspection object.

In this context, the X-ray detector includes at least one detector line having at least one (optionally a plurality of) detector element (s) arranged along the detector line.

It should be noted that the detector line may also be composed of a plurality of sections, each including a respective sub-detector line.

In the context of the arrangement proposed herein, “line-shaped” shall initially be understood to mean that the detector is arranged to acquire detector data for a plurality of image points in the longitudinal direction of the detector (i.e., orthogonal to the scan or transport direction of the inspection object) and for a smaller number of image points, but for at least one image point, orthogonal to the longitudinal direction (i.e., in the scan or transport direction of the inspection object).

In the simplest implementation, the detector thus has a line with a certain number N of detector elements in the longitudinal direction of the line (for example N=n) and has a number M=1 orthogonal to the line, i.e. is exactly one single detector element wide. I.e., the detector line is a special case of a detector matrix with NxM detector elements, where N=n and M=1.

In principle, the detector can have more than one detector element in the direction orthogonal to the longitudinal direction (i.e., in the scanning direction or transport direction of the inspection object) with M>1, i.e., the detector is then a detector matrix with NxM detector elements. The principles proposed here with reference to a detector line (N=n and M=1) can be applied accordingly to a matrix detector (N=n and M=m with m< >1) and can further increase the spatial resolution there.

The shielding element is arranged (in the direction of an incident X-ray beam) in front of the receiving area for the X-rays of the at least one detector element and has one or more regions opaque (impermeable) to the X-rays and at least one region transparent (permeable) to the X-rays. A region opaque to the X-rays can be achieved, for example, by having the material of the shielding element absorbing and/or reflecting X-rays.

In the arrangement proposed herein, the shielding element and the at least one detector element are movable relative to each other so that the effective receiving area for the X-rays of the at least one detector element is correspondingly variable in time. As a result, the shielding element together with the relative movement acts as a dynamic aperture for the detector element.

With the arrangement according to the first aspect, the shielded area of the receiving area of the detector element and thus the effective (effective) receiving area of the detector element can be (temporally) varied over time so that scanning of different regions of the area of the same detector element becomes possible. Since the effective receiving area of the detector element is smaller than the actual maxima receiving area of the detector element due to the intended time-varying scanning, the resolution achievable with the detector element is increased accordingly.

Theoretically, an almost arbitrarily high resolution of the X-ray detector can be achieved by means of the proposed arrangement, in that the readout frequency of the detector element, the relative movement between the detector element and the shielding element, and the movement of the inspection object are matched accordingly.

The “(maximum) receiving area” is understood here as the maximum area of a detector element on which the X-rays are incident and generate an associated irradiance there, from which an intensity value associated with the received X-rays can be determined by measurement or calculation.

The “operative (effective) receiving area” of a detector element is understood here as the area of the detector element on which X-rays to be detected, which have passed through the inspection object, are incident in the proposed arrangement due to the shading caused by the shielding element. In other words, the “effective receiving area” of the detector element corresponds to the partial area of the (maximum) receiving area that is just not shielded by the shielding element. Therefore, the “effective receiving area” may be smaller than or equal to the (maximum) receiving area of the detector element.

It will be appreciated that “relative movement” between the shielding element and the at least one detector element can be achieved in various ways, for example, by the shielding element being stationary and the detector being moved, or, by the shielding element being moved and the detector being stationary, or, by both the shielding element and the detector being moved relative to each other.

In an arrangement as intended when scanning an inspection object with X-rays, the detector of the arrangement of the first aspect proposed herein may be arranged with the line direction orthogonal to the scanning direction of the inspection object so that the inspection object can be scanned line by line. Thereby it may be that no movement of the inspection object takes place in the direction of the achieved increase of the resolution. The shielding element may have one or more regions that are opaque to the X-rays (hereinafter referred to as “opaque region”) and one or more regions that are transparent to the X-rays (hereinafter referred to as “transparent region”). The shielding element thus shows at least one alternation between at least one opaque region and at least one transparent region. According to the intersection of transparent region and receiving area of the detector element, a passage of the X-rays to the detector element and thus a corresponding detection of incident X-rays is possible.

In principle, the transmissive region(s) of the shielding element can have any shape and size. For example, the shielding element may have a regular pattern, or an irregular pattern formed by the transparent and opaque regions. An irregular pattern could be a random pattern, for example.

At any instant, the intersection of the shape and size of the transparent region of the shielding element and the shape and size of the receiving area of the detector element together determines the current effective receiving area of the detector element.

The opaque region(s) of the shielding element may be made of a material that is opaque to X-rays, i.e., absorbs them. For example, an opaque region may be made of a material with a higher density, such as metals, such as lead.

In the simplest implementation, the transmissive region (s) may be a recess in the opaque region of the shielding element. As described above, the shielding element may have a single recess or multiple recesses.

If the shielding element has multiple recesses, they may all have the same shape or different shapes; i.e., the recesses may be arranged all identically or with different sizes and shapes. The multiple recesses may be arranged regularly or irregularly on the shielding element. In other words, multiple recesses on the shielding element may form a regular or irregular (for example, random) recess pattern.

Alternatively to a material recess, a transparent region on the shielding element may be made of a material transparent to X-rays. For example, a material with a low density, such as a plastic, glass, or wood, could be used for this.

For example, one or more material recesses in the shielding element may be filled with a material transparent to X-rays. In this case, the shielding element includes a compact composite material with at least two different materials, one material being transparent to X-rays and the other material being opaque to X-rays.

The shielding element itself can have almost any geometric shape. In any case, it should be possible to arrange the shielding element relative to the detector and thus to the detector elements in such a way that, by means of a defined relative movement between the detector and the shielding element, a correspondingly time-defined change in the effective receiving area of the detector element can be achieved.

The X-ray opaque part of the shielding element can, for example, be comb-shaped, i.e. have the form of a comb with a longitudinal part on which a number of regular or irregular teeth or tines are arranged. The space between the teeth then corresponds to the X-ray transparent region (s) of the shielding element. If this comb-shaped shielding element is arranged with its longitudinal direction aligned in the direction of the line direction of the detector with the tines above the detector, the teeth of the comb form the opaque regions and the spaces between the teeth form the transparent regions of the shielding element.

Alternatively, the shielding element may be disk-shaped, i.e., have the form of a disk with an outer edge region which may be similar to the region of the above-mentioned comb with teeth or tines, the teeth being directed substantially radially outwardly from the center of rotation of the disk. To this end, a disk-shaped shielding element may have a plurality of edge transparent regions in the form of recesses which are arranged uniformly or unevenly along the circumference of the disk, i.e., at the edge. For example, the shielding element could be an encoding disk or a spiral disk. Alternatively, the shielding element can be belt-shaped or belt-shaped, i.e., have the shape of a belt. One or more transparent regions can be arranged as recesses along the longitudinal direction of the belt in the belt. Again, the transparent regions may always have the same shape or different shapes and may be arranged regularly or irregularly along the longitudinal direction of the belt.

Alternatively, the shielding element may be tubular, i.e. have the shape of a tube. The tubular shielding element may be arranged in its longitudinal direction encompassing the detector line. Similar to the belt-shaped shielding element, one or more transparent regions of the same or different shape may be arranged in the jacket or lateral surface of the tube. Alternatively, a transparent region may extend spirally around the tube in the longitudinal direction in the tube jacket. For example, the tube may be cylindrical in the simplest case, but any other tube cross-sections are possible.

The relative motion between the shielding element and the detector may be achieved by rotation, translation, and/or a combination of rotational and translational motion of the shielding element and/or the detector.

The relative motion between the shielding element and the detector may be a periodic motion, such as an oscillating motion.

For example, the above mentioned comb-shaped shielding element may be arranged in a plane defined by the teeth of the comb parallel to the receiving area of the detector elements of the detector and reversibly movable between two end positions. The relative movement between a first end position and a second end position may be an oscillating movement. As a result, the effective receiving area of the detector elements is changed cyclically.

For example, the above-mentioned disc-shaped shielding element can be arranged rotating about an axis orthogonal to the receiving areas of the detector elements of the detector or oscillating over a certain angular range relative to the detector.

For example, the above-mentioned tubular shielding element can be arranged rotating about an axis parallel to the longitudinal axis of the detector or alternatively oscillating over a certain angular range relative to the detector.

The way in which the relative movement between the shielding element and the detector is configured, in particular concerning the speed of movement, determines the dynamic change in the effective receiving area of the detector elements of the detector caused thereby.

The transmissive region of the shielding element may have a stepped profile with respect to a detector element and the configured relative movement between the shielding element and the detector.

The “stepped profile” feature is understood herein with respect to the configured relative movement in that the transparent region for a particular detector element is configured such that when the shielding element and the at least one detector element are moved relative to each other, the effective X-ray receiving area of the at least one detector element is correspondingly variable in predetermined steps.

Based on each respective step, the associated detector element is partially shielded or irradiated from X-rays, wherein the effective receiving area is variable in steps by a predetermined percentage. For example, the profile of the transparent region may be staircase-shaped with uniform or non-uniform steps.

For example, the staircase shape may have four uniform steps such that the effective receiving area can be varied by 20% each, from 0% transmissivity through 20%, 40% and 60% successively to 80%. A state with complete masking or shielding of the detector is also possible. Likewise, an irregular gradation would also be conceivable.

To enable the relative movement between the shielding element and the at least one detector element, the shielding element can be coupled to a first actuator and/or the detector row can be coupled to a second actuator. As actuators can be employed mechatronic driving elements such as piezo crystal actuators or electromagnetic actuators.

The first actuator and/or the second actuator may be coupled to a control unit for generating the relative motion, which controls both of the actuators or one of the actuators accordingly.

The shielding element may further be configured to be moved from its shielding position to a deposit or parking position, such that the detector elements are no longer shielded. This position of the shielding element may be used to enable conventional X-ray inspection of an inspection object, i.e. with a low resolution but with a higher scanning speed.

A second aspect provides an X-ray inspection apparatus including the arrangement according to the first aspect.

The X-ray inspection apparatus is configured for transporting an inspection object in a transport direction through the X-ray inspection apparatus. The line direction of the detector may be arranged orthogonal to the transport direction, i.e., the scanning direction of the inspection object, such that the transport direction corresponds to the scanning direction for the inspection object. The X-ray inspection apparatus is configured to provide intensity values for X-rays of the respective effective receiving surface for X-rays of the at least one detector element for different points in time when scanning an inspection object.

With the X-ray inspection apparatus of the second aspect, an imaging X-ray radiography for a non-destructive inspection of the inspection object can be performed. The provided intensity values are based on detecting X-rays penetrating the inspection object with the detector of the arrangement of the first aspect.

A third aspect of the present disclosure relates to a method for increasing the spatial resolution of an X-ray detector having at least one detector line with at least one detector element. In particular, the at least one detector element and a shielding element disposed over the receiving area for the X-rays of the at least one detector element are movable relative to each other, whereby the effective receiving area for the X-rays of the at least one detector element can be changed. The method of the third aspect may use the arrangement of the first aspect in an X-ray inspection apparatus of the second aspect. The method of the third aspect including the steps of:

A first step of first reading the at least one detector element at a first point of time t, during which a first effective area of the at least one detector element has been irradiated by X-rays.

A second step of second reading the at least one detector element at a second point of time t+1, during which a second effective area of the at least one detector element has been irradiated by X-rays.

A third step of calculating associated intensity values of the X-rays for the first effective area at the first point of time t and the second effective area at the second point of time t+1.

If a transparent region of the shielding element is designed to be already small enough, i.e. to have the desired partial detector element size, the intensity values read out directly correspond to these desired effective areas (i.e. partial areas) of the detector element for the desired increased resolution.

If required, the partial detector element size can additionally or alternatively be further reduced by determining intensity values for virtual small effective areas, which are determined as intermediate values between successive readouts of the detector elements. For this purpose, the method may include a further, i.e. fourth, step, in which the intensity values calculated in the third step (successive in time) are subtracted in order to determine a virtual intensity value of the X-rays for a partial area of the at least one detector element based on the subtraction in the third step.

As a result, by means of the fourth step an additional intensity signal for a virtual (smaller) pixel can be determined by the above mentioned subtraction of the detected intensities from the real intensity values of the two successive sampling points of time t and t+1. The second area and the first area should overlay or overlap at least in a partial area.

The change in the relative arrangement between the shielding element and the at least one detector element can be synchronized with the readout and exposure of the associated detector element to X-rays. This is particularly advantageous when the transmissive region of the shielding element has a stepped profile.

The exposure of a detector element requires a certain exposure time. During this exposure time, two movements take place: The relative movement between the detector (element) and the shielding element, and the movement of the inspection object to be scanned in the X-ray fan aligned with the detector. Ideally, these two movements are negligible (slow) compared to the exposure time. To fast movements may result in blurs in the transmission image derived from the intensity data. If the relative motion is slow and the object is moving slowly or at a high scanning frequency, this problem is negligible.

To reduce the negative effect of the relative motion, even with longer exposure times, the above-mentioned shielding element with stepped profiled transparent regions has proven effective. The effective exposure areas of the detector elements to be exposed are kept constant over a longer period of time and then changed by a predetermined step within a short period of time (i.e. in a step function-like manner). The exposure with X-rays can then be synchronized with the phases in which the effective exposure area of the detector element is constant. As a result, only a movement of the inspection object may remain as a negative effect.

A fourth aspect relates to a processing device for processing the intensity values provided by the X-ray inspection apparatus of the second aspect, the processing device being configured to perform the method of the third aspect. In a particular implementation, the processing device may be integrated into the detector and shielding element arrangement such that the detector data provided by the detector corresponds to that of a detector having a correspondingly higher physical resolution. The processing device may alternatively be integrated into a control unit of an X-ray inspection apparatus such that the detector or image data provided by the apparatus for evaluation also already have the higher spatial resolution.

A fifth aspect of the present disclosure relates to a system including an X-ray inspection apparatus of the second aspect and the processing device of the fourth aspect, wherein the X-ray inspection apparatus is configured to provide intensity values based on a scan of an inspection object to the processing device and is connected to the processing device for corresponding data communication thereto.

A sixth aspect of the present disclosure relates to a computer program product or a data carrier including the computer program product, the computer program product including a computer program with software means for implementing a method of the third aspect when the computer program is executed on a computer, such as the processing device of the fourth aspect. A seventh aspect of the present disclosure relates to a data stream including electronically readable control signals that can interact with a programmable computer such that when the computer executes the electronically readable control signals, the computer performs a method of the third aspect.

### BRIEF DESCRIPTION OF THE DRAWINGS

Further advantages, features, and details of her proposed solution (s) are apparent from the following description, in which embodiments are described in detail with reference to drawings. In this connection, the features mentioned in the claims and in the description may each be essential individually or in any combination. Likewise, the features mentioned above and those further elaborated here may each be used individually or in any combination. Functionally similar or identical parts or components are partially provided with the same reference signs. The terms “left”, “right”, “top” and “bottom” used in the description of the embodiments refer to the drawings in an orientation with normally readable figure designation or normally readable reference signs. The embodiments shown and described are not to be understood as exhaustive but have an exemplary character for ex-plaining the solution proposed here. The detailed description is intended to inform the person skilled in the art, therefore known structures and methods are not shown or explained in detail in the description in order not to complicate the understanding of the description.

FIG. 1a is a simplified perspective view of the structure of an arrangement for increasing the spatial resolution of an X-ray detector by means of a dynamically variable aperture.

FIG. 1b is a view of the cross-section through the xy-plane of the arrangement of FIG. 1a.

FIG. 1c is a functional block diagram of the arrangement for increasing the spatial resolution of the X-ray detector of FIGS. 1a and 1b.

FIG. 2 is a simplified perspective view of the structure of an embodiment of the arrangement proposed herein.

FIG. 3a is a simplified perspective view of the structure of another embodiment of the arrangement proposed herein.

FIG. 3b illustrates a detail of the embodiment of FIG. 3b.

FIG. 3c is a simplified illustration for determining a virtual intensity value of the X-ray radiation of a partial area of a detector element in the embodiment of FIG. 3a.

FIG. 4 is a simplified perspective view of the structure of a further embodiment of the arrangement proposed herein.

FIG. 5 is a simplified perspective view of the structure of a further embodiment of the arrangement proposed herein.

FIG. 6 is a simplified perspective view of the structure of a further embodiment of the arrangement proposed herein.

FIG. 7a is a simplified perspective view of the structure of a further embodiment of the arrangement proposed herein.

FIG. 7b is a simplified view of the determination of a virtual intensity value of detected X-rays of a partial area of the detector elements according to the embodiment of FIG. 7a.

FIG. 8a is a block diagram of a system including an X-ray inspection apparatus and a processing device.

FIG. 8b is a simplified side view of an X-ray inspection apparatus with an arrangement proposed herein, such as an arrangement of FIGS. 2-7a.

FIG. 9 illustrates a method for dynamically increasing the spatial resolution of the X-ray detector.

### DETAILED DESCRIPTION

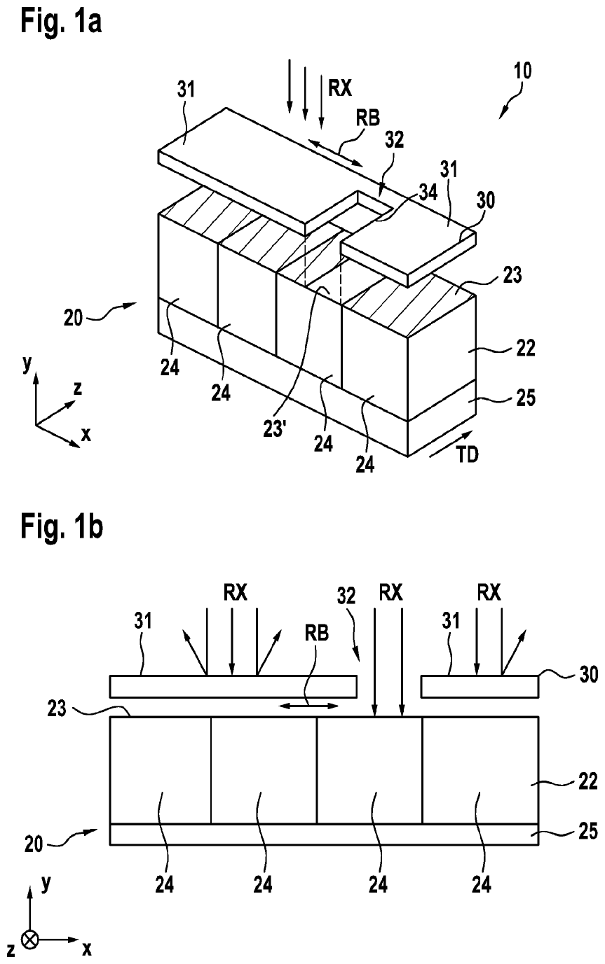

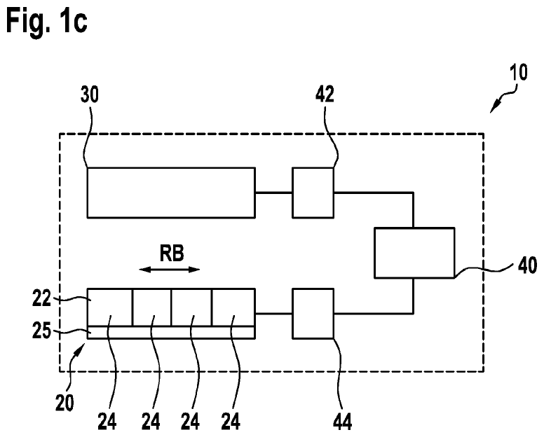

FIGS. 1a and 1b show an arrangement 10 for increasing the spatial resolution of an X-ray detector 20 in a simplified representation.

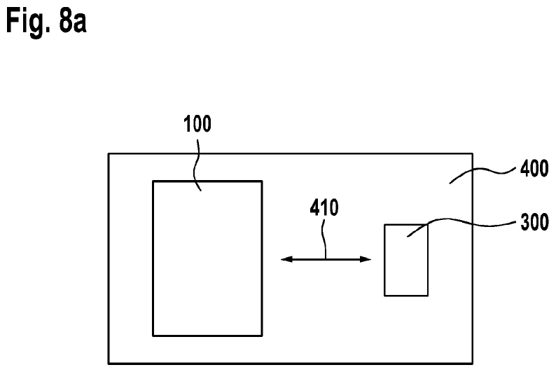

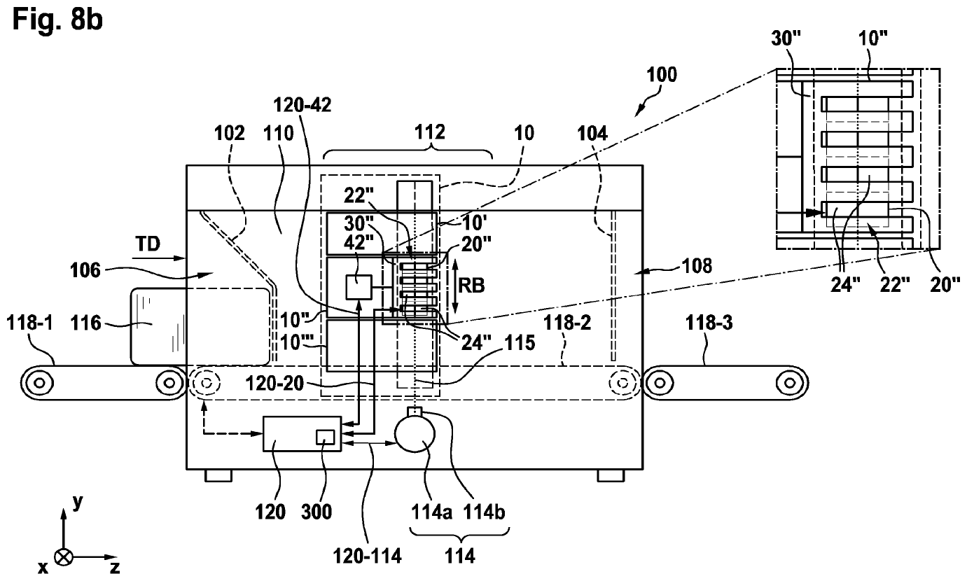

The description of FIGS. 1a and 1b should be preceded by the fact that in the Figures, for orientation and mutual reference, an xyz coordinate system is plotted in each case, according to which the longitudinal direction of the detector lines shown always runs in the x-direction, while the direction of X-rays RX (simplified as arrow bundle) incident on the detector elements to be detected runs in y-direction and finally, when using the detector lines, a direction corresponding to the scanning direction runs orthogonal to the detector line in z-direction. The scanning direction usually corresponds to the transport direction TD of an inspection object past the detector line and through an X-ray inspection apparatus (as shown, e.g., simplified in FIG. 8). I.e., the longitudinal direction (x-direction) of the detector proposed here is usually arranged in use transversely to the scanning direction (z-direction).

FIGS. 1a and 1b illustrate the structure of an arrangement 10 with an X-ray detector 20 (hereinafter referred to as detector 20 for short) in the form of a section of a detector line 22. FIG. 1a is a simplified perspective view of the arrangement 10 and FIG. 1b is, for the purpose of illustrating the construction, a projection of an arrangement 10 of FIG. 1a onto the xy-plane.

The detector line 22 includes detector elements 24 arranged side-by-side; for reasons of clarity, only four such elements are shown, although in principle there are no limits to the number in reality. The detector elements 24 may lie on a carrier element 25.

Although not shown in the Figures, for use in known dual-energy radiography, each detector element 24 may include a low detector element selective for low-energy X-rays and a high detector element selective for high-energy X-rays, respectively, sandwiched with respect to X-rays RX to be detected, with an intervening filter layer (e.g., of copper). During the scanning of an inspection object, the detector elements 24 generate detector data based on respective detected X-rays RX. The detector 20 has at least one output channel at which the detected detector data is provided.

In use, the detector line 22 is usually arranged transversely to a transport direction TD for an inspection object (e.g. 116, FIG. 8b) so that the inspection object can be scanned line-by-line with the X-rays RX. As already noted elsewhere, the detector 20 can in principle also include a plurality of detector lines 22 arranged one behind the other in the direction of transport, which then form a two-dimensional detector matrix or a two-dimensional matrix detector; the statements made and measures explained here using the example of a detector line can be transferred directly to a matrix detector.

The arrangement 10 further has a shielding element 30 which is arranged above the upper surface of the detector 20. The upper surface of the detector 20 is formed by the receiving area 23 of each of the detector elements 24. The shielding element 30 includes a region 31 which is opaque to the X-rays RX, in that the X-rays RX are reflected and/or absorbed there, and a region 32 which is transparent to the X-rays RX, in which the X-rays RX pass through the shielding element as unaffected as possible and impinge on the receiving area of the detector 20. It should be noted that in the FIGS. 1a and 1b, only for a simple explanation of the principle proposed here, there is only one transmissive region 32 in the shielding element 30. The area of the detector element 24 which is impinged by the X-rays RX defines the effective receiving area 23′. Since the shielding element 30 and the detector 20 or, respectively, the detector elements 24 are movable relative to each other (see the double arrow in the FIG. 1a), the effective receiving area 23′ can be dynamically changed by means of this arrangement.

The transparent region 32 of the shielding element 32 thus functions as a dynamic aperture for one or more detector elements 24.

In the FIG. 1a, the one transparent region 32 is designed as a rectangular recess 34. In the intended operation of the arrangement 10, the shielding element 30 is displaced relative to the detector elements 24 orthogonal to the beam direction (for example oscillating in line direction). Thus, the effective receiving area 23′ corresponds to the parallel projection of the X-rays RX on the upper surface of the detector 20 or, respectively, on the receiving area of the detector elements 24. In other words, the shape of the effective receiving area 23′ corresponds to the profile or the clear region of the recess 34.

FIG. 1c illustrates the arrangement 10 for increasing the spatial resolution of the detector 20 as a block diagram.

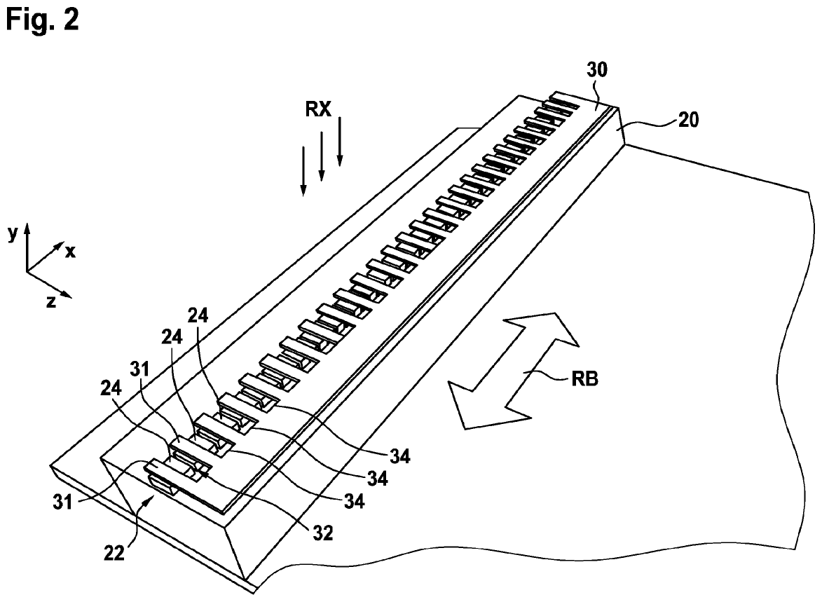

The arrangement 10 includes the shielding element 30 and the detector 20, which includes a plurality of detector elements 24. A control unit 40 controls a first actuator 42 and/or a second actuator 44 to control, especially to perform deterministically, the relative movement between the shielding element 30 and the detector 20. The first actuator 42 is coupled to the shielding element 30 and the second actuator 44 is coupled to the detector 20. In principle, the intended relative movement can also be achieved by means of only one of the two actuators 42, 44. In a particular implementation, there is only the first actuator 42, which moves the shielding element 30 as a dynamic aperture. For example, a piezoelectric actor or actuator (piezo actuator) can be used as an actuator 42 and/or 44. FIG. 2 shows a first embodiment of the arrangement 10 of FIG. 1c. Here, the shielding element 30 is comb-shaped, i.e. has the shape of a comb, which can be moved oscillatingly in the line direction of the detector (arrow RB) relative to the detector 20 and thus the detector elements 24. For this purpose, the shielding element 30 oscillates between a first position P1 and a second position P2.

The comb-shaped shielding element 30 is configured in such a way that the teeth or prongs of the comb each have an opaque region 31 and the recesses 34 (i.e. the spaces between the teeth) correspond to the transparent regions 32, the opaque regions 31 always shielding a sub-region of the receiving area of each detector element 24 and the transparent regions 32 being arranged over the remaining sub-region so that the difference between these two sub-regions corresponds to the effective receiving area 23′ (cf. FIG. 1a).

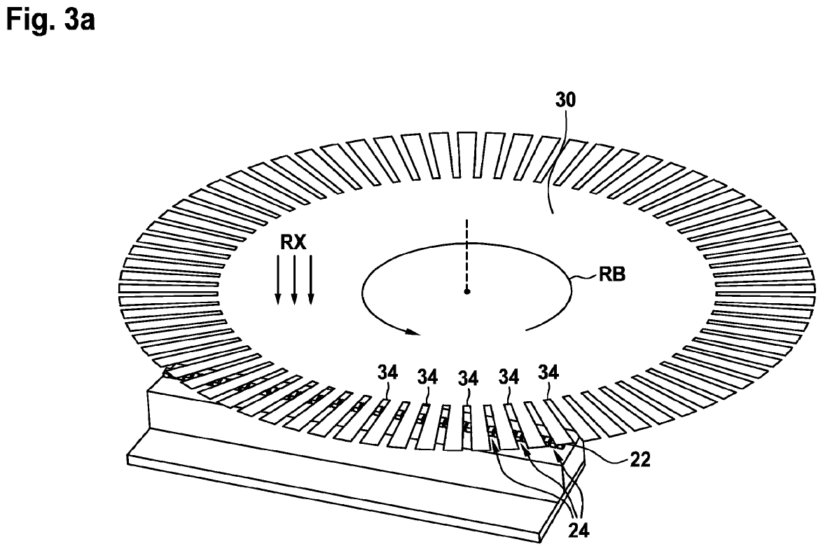

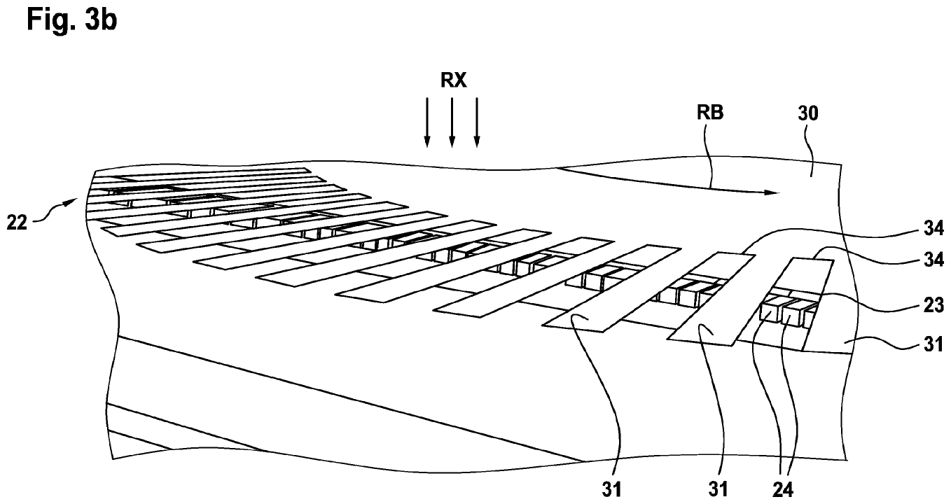

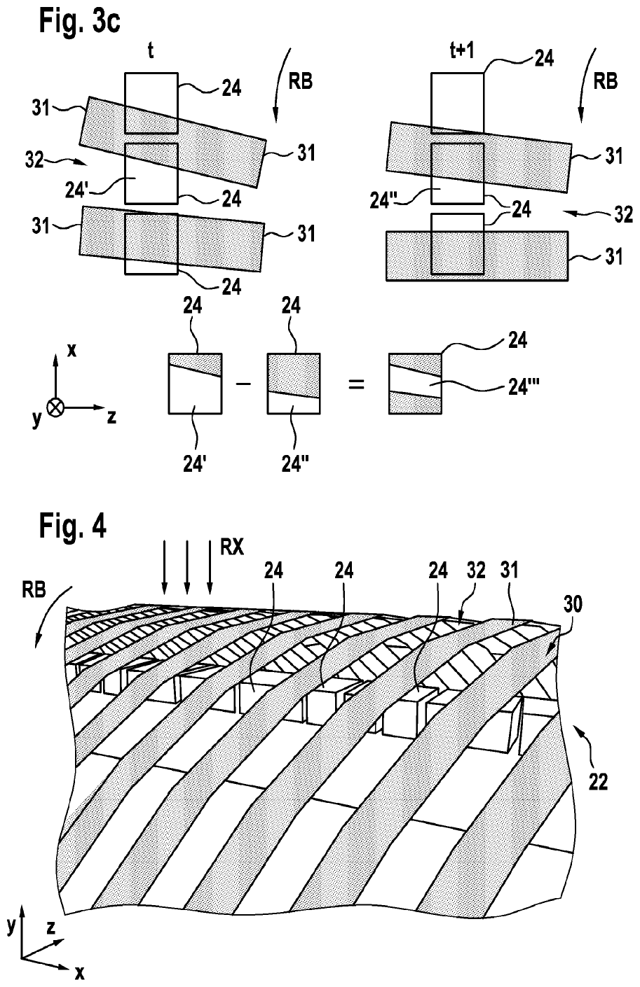

FIGS. 3a and 3b illustrate a second embodiment of the arrangement 10 of FIG. 1c, wherein the shielding element 30 has the form of a disc. The surface of the disk defines a plane parallel to the receiving surfaces 23 of the detector elements 24 and is configured such that the transparent regions 32 are regular recesses 34 extending radially outward from the center of rotation along the edge of the disk. The change between the regions 31 which are opaque to X-rays RX and the transparent regions 32 is achieved by rotation (or alternatively an oscillation over a certain angular range) of the disk about an axis orthogonal to the receiving surfaces 23 of the detector elements 24.

FIG. 3c shows a section of a simplified top view of the disk-shaped shielding element 30 of FIGS. 3a and 3b to illustrate a further development of the principle proposed here, by means of which the spatial resolution of the detector can be additionally increased. FIG. 3c shows only the edge of the disk-shaped shielding element 30 in detail, at which opaque regions 31 and transparent regions 32 alternate, whereby a relative movement of two recesses 34 arranged at the edge is illustrated over three detector elements 24 of the detector.

For example, the detector element 24 arranged in the center is read out at a first point of time t, during which a first (partial) area 24′ is irradiated by X-rays RX. In the course of this, the irradiated (partial) area 24′ corresponds to the current effective receiving area of this detector element 24.

The same detector element 24 is then read out at a next, i.e. subsequent, second point of time t+1, during which a second (partial) area 24″ is irradiated by X-rays RX. Due to the relative movement between the shielding element 30 and the detector elements 24, the first area 24′ does not correspond to the second area 24″. The two (partial) areas 24′ and 24″ overlap.

As explained elsewhere, the increase in physical resolution of a detector element achievable by means of the arrangement proposed here is directly dependent on the size of the regions 32 in the shielding element 30 that are transparent to X-rays. If a further reduction of the area of a pixel is desired, this can be achieved with the subtraction of successive detected real intensity values to determine an intensity value for a virtual (smaller) pixel, already described here in the general part.

For this purpose, the associated intensity values of the X-rays RX detected at the respective points of time t and t+1 for the first (partial) area 24′ and the second (partial) area 24″ are initially detected or calculated (if, for example, integration over a scanning time period is performed). Subsequently, the two intensity values are subtracted from each other in order to determine therefrom the virtual intensity value for X-rays RX of the (smaller) partial area 24′″ of the detector element 24.

It should be noted that the above-described further development of the method for determining a virtual intensity value of detected X-rays RX can be applied to any of the embodiments for the arrangement 10 presented here accordingly for a further increase in spatial resolution.

FIG. 4 shows a third embodiment of the arrangement 10 of FIG. 1c, in which the shielding element 30 is tubular, i.e. has the shape of a tube surrounding the detector line 22. The shielding element 30 has a slot extending spirally in the longitudinal direction of the tube and in the jacket of the tube, which slot is transparent to X-rays RX, while the remaining tube jacket is opaque to X-rays RX. Thus, in the arrangement 10 of FIG. 4, opaque regions 31 and transparent regions 32 alternate regularly in the longitudinal direction of the detector line 22. The desired relative movement between the shielding element and the detector and the associated change in the effective receiving areas of the detector elements is achieved by a rotation of the tube about its axis, which is arranged parallel to the line direction of the detector line 22, and thus about the detector line 22.

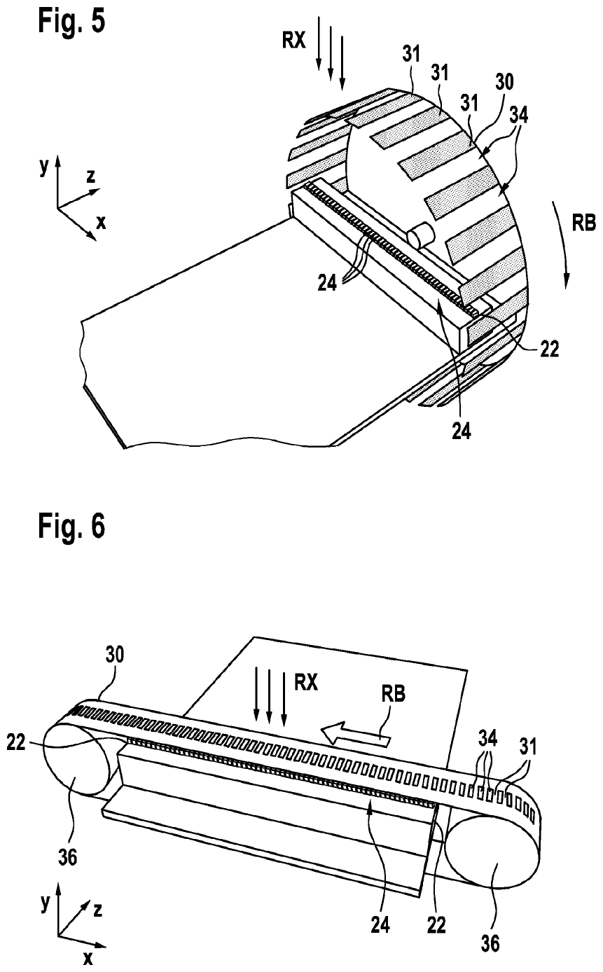

FIG. 5 illustrates a fourth embodiment of the arrangement 10 of FIG. 1c, wherein the shielding element 30 is wheel-shaped, i.e., includes the shape of a wheel. Unlike the shielding element 30 of FIGS. 3a-3c, the shielding element 30 of FIG. 5 is configured such that the wheel is rotatable about an axis parallel to the receiving surfaces 23 of the detector elements 24 and includes a plurality of teeth or prongs (similar to those of the comb of FIG. 2) arranged at the edge of the wheel and extending orthogonally from the plane defined by the wheel from the edge of the wheel. The teeth again form the opaque regions 31 and the spaces between two adjacent tines form the transparent regions 32. Rotation of the wheel about its axis or oscillation of the wheel over a certain angular range about the axis produces the desired relative movement of the teeth over the receiving areas 23 of the detector elements 24, so that again a corresponding change in time of the effective receiving area of the detector elements is achieved.

FIG. 6 illustrates a fifth embodiment of the arrangement 10 of FIG. 1c, wherein the shielding element 30 has the form of a belt with a plurality of rectangular recesses 34 arranged regularly in the belt direction. The change between the opaque regions 31 and the transparent regions 32 is achieved by the movement of the belt around two rollers 36. The shielding element 30 can run continuously in one direction or change the running direction at certain times, i.e. also oscillate between two positions. The detector line 22 is arranged under the belt and between the rollers 36 in this arrangement.

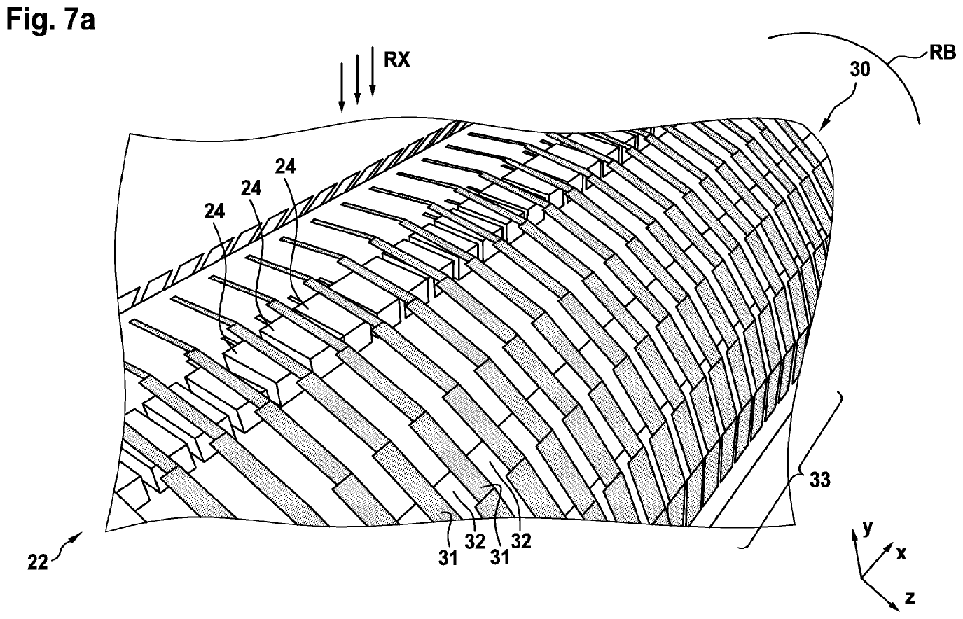

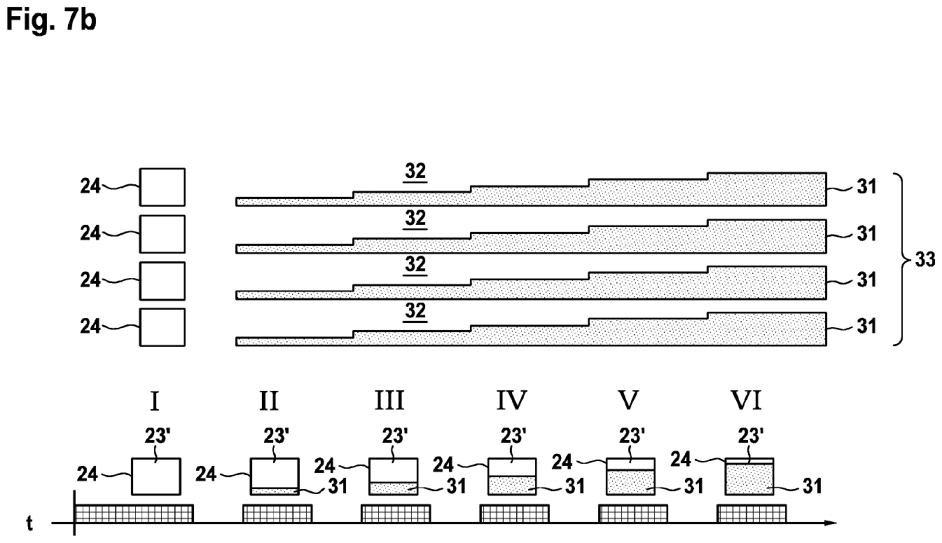

FIG. 7a shows a sixth embodiment of the arrangement 10 of FIG. 1c, wherein the shielding element 30 is tubular similar to that in FIG. 4 and includes the detector line 22. Unlike the shielding element 30 shown in the FIG. 4, the tube in the FIG. 7a does not have a spiral slit as the X-ray transparent region but includes a plurality of X-rays RX shielding sub-elements 33 arranged longitudinally side-by-side and having a stepped profile in the circumferential direction of the tube such that the area of the transparent region for an associated detector element can be varied by rotation of the tube. When the tubular shielding element 30 is rotated about its axis, which is arranged parallel to the line direction of the detector line 22, each sub-element 33 changes the receiving area of an associated detector element 24 in a gradual or step-like manner. The effective receiving area of each detector element 24 is thereby changed accordingly in steps. The partial elements 33 shielding X-rays RX thus correspond to the opaque regions 31 and are arranged next to each other in such a way that the transparent regions 32 themselves also have a graduated profile.

FIG. 7b illustrates a gradual or stepped change in the effective receiving area 23′ of a detector element 24 when using an arrangement 10 having a shielding element 30 similar to the shielding element 30 shown in FIG. 7a. For ease of illustration, FIG. 7b shows the stepped profile of an X-ray opaque region with five steps in each case; of course, more or less steps, but also irregular (e.g. random) steps are possible.

In FIG. 7b, for each detector element 24, a correspondingly stepped opaque area 31 with five evenly spaced steps is provided. The space between the adjacent opaque regions 31 corresponds to the respective transparent region 32 of the shielding element 30.

In the relative movement RB (cf. FIG. 7a) of the shielding element 30 relative to the detector elements 24 (here the rotation of the tubular shielding element 30 about an axis of rotation which runs parallel to the line direction of the detector line 22), each detector element 24 is partially or finally completely shielded and the effective receiving area 23′ is changed again and again in the course of time by a certain percentage set by means of the stepped profile (here shown as 20% for illustration purposes).

It should be noted that the stepped profile of the opaque region 31 shown in the FIG. 7b can be arranged exactly once or several times in succession along the circumference of the tubular shielding element 30 (cf. FIG. 7a).

For the discussion of FIG. 7b it is assumed that there are, in one rotation of the shielding element 30 (cf. FIG. 7a), exactly six different time periods (I)-(VI), in the sequential course of which the opaque region 31 changes the effective receiving area of the associated detector element 24 gradually (in 16.7% steps) from not shielded (0%) to almost completely shielded (83.3%).

In the first time interval (I), the opaque region 31 of the shielding element 30 is not yet arranged over the receiving area of the detector element 24. Thus, the receiving area of the detector element 24 is completely irradiated by X-rays RX.

As soon as the shielding element 30 moves in the direction of the detector element 24 (in the FIG. 7b this corresponds to a movement of the unrolled lateral surface of FIG. 7a to the left), the opaque region 31 begins to shield the detector element 24 by 16.7%. At the time interval (II), the 16.7% stage of the opaque region 31 shields the detector element 24 accordingly. Thus, the size of the effective receiving area 23′ is reduced by 16.7% corresponding to the size of the first stage.

Moving further to the left, the 33.3% stage of the opaque region 31 starts shielding the detector element 24 accordingly for the third time interval (III), eventually the 33.3% stage of the opaque region 31 shields the detector element 24 accordingly by 33.3%.

The movement of the shielding element 30 continues accordingly until finally the sixth time interval (VI), in which the effective receiving area 23′ is shielded accordingly by the last 83.3% stage.

Since the shielding element 30 is in fact tubular, as shown in the FIG. 7a, the method would start again at the first time intervall (I) with the 0% stage of the step-profiled opaque region 31.

Alternatively, the shielding element may be configured for an oscillating rotational movement between the first and sixth profile sections, so that the above-described method would be run backwards after the time interval (VI) back to the time interval (I).

In a further development, in order to increase the degree of accuracy of the spatial resolution of the detector 10, the movement of the shielding element 30 is synchronized with the irradiation of the detector elements with X-rays RX. The checkered areas shown on the timeline t of the FIG. 7b illustrate the synchronized activation of the irradiation or illumination of the detector elements 24. Thus, the intensity values are measured exactly in the predetermined time intervals (I) to (VI). I.e., whenever, for example, a certain profile stage of the opaque region 31 shields the receiving area 23 of the detector element 24 in such a way that the effective receiving area is constant for the time interval. During the transi-tion phase from one profile stage to the next, the illumination is switched off electronically (for example, by switching off the radiation source or closing off an associated collimator—cf. FIG. 8b).

FIG. 8a illustrates a system 400 including an X-ray inspection apparatus 100 and a processing device 300, the processing device 300 operatively interacting with the X-ray inspection apparatus 100 in accordance with the principles described herein via a communication link 410 to enable any of the methods described herein for obtaining the effective spatial resolution of the detector 20 disposed in the X-ray inspection apparatus 100.

In FIG. 8b, an X-ray inspection apparatus 100 is shown in a significantly simplified form as an example. The X-ray inspection apparatus 100 includes two radiation shielding curtains 102, 104, one of which is arranged at each of an input 106 and an output 108 of a radiation tunnel 110 of the X-ray inspection apparatus 100. Between the radiation shielding curtains 102, 104 within the radiation tunnel 110 is a radiation area 112 in which at least one radiation source 114 for ionizing radiation is arranged; for example, an X-ray tube 114a with a collimator 114b for generating an X-ray fan 115 aligned with an X-ray detector 20. The X-ray fan can be turned on and off by activating and deactivating the X-ray tube 114a and/or closing the collimator 114b.

The X-ray inspection apparatus 100 further includes one of the arrangements 10 proposed herein in various embodiments according to the principle explained in the FIGS. 1a-1c, wherein the shielding element 30 is arranged between the detector 20 and the radiation source 114.

Without establishing any prioritization therewith, solely for the purpose of illustration in the FIG. 8b the arrangement 10 according to the principle of the FIG. 2 is shown. Additionally, for an easier and clearer representation, only one detector sub-unit 10″ is shown as a section of the entire detector arrangement 10. This also corresponds to the implementation in practice, whereby line- or matrix-shaped detectors in line scanners for a line- or matrix-wise scanning of inspection objects are usually composed of a corresponding arrangement of several detector sub-units. In accordance with this common implementation, only the detector subunit 10″ is shown in detail in the FIG. 8b as a section of the entire detector arrangement 10, which in the example shown includes the three detector sub-units 10′, 10′, 10′″. Further, the detector 20 shown is a matrix detector which is two detector elements 24 wide in the scanning direction.

A transport device, for example a sliding belt conveyor having three sections 118-1, 118-2, 118-3, is used to transport a baggage item 116 as an example of an inspection object in the transport direction TD through the radiation tunnel 110.

The line-shaped detector 10 is space-efficiently L-shaped or U-shaped and arranged with its longitudinal direction (i.e., line direction) orthogonal to the transport direction TD, such that the transport direction TD corresponds to the scanning direction of an inspection object.

The section of the detector 10 formed by a detector sub-unit 10″ in the representation of FIG. 8b includes the associated matrix detector 20″, which corresponds to a section of the entire (matrix) detector line 22, above which a comb-shaped shielding element 30″ is arranged. The shielding element 30″ is connected to an actuator 42″ (for example, a piezo-mechanical actuator) so that the actuator 42″ can reciprocate the shielding element 30″, as an example of one of the relative movements RB proposed herein, i.e., in the line direction, to act as a dynamic aperture for the detector elements 24″.

In order to synchronize the readout of the detector elements 24″ of the detector subunit 10″ with the relative movement RB of the shielding element 30″, the actuator 42″ is controlled by a control unit 120 of the X-ray inspection apparatus 100 via a corresponding control connection 120-42. The control unit 120 is configured to read out the respective detector elements 24″ via a readout connection 120-20 in synchronization with the relative movement RB of the shielding element 30″, as well as to switch on and off the X-ray fan 115 via a control connection 120-114 by correspondingly activating and deactivating the X-ray tube 114a and/or opening and closing a radiation output of the collimator 114b.

The processing device 300 is substantially configured to perform at least one of the methods proposed herein and to process the detector data acquired by the arrangement 10.

It will be appreciated that the arrangement 10 may alternatively be one as shown in simplified form in the FIGS. 3-7b, or another arrangement following the principle proposed herein.

The detector data provided by the X-ray detector 20 and processed by the processing device 300 can be used to produce a colored X-ray image of the inspection object 116 based on material classes with increased spatial resolution, which can be displayed to an operator on a screen (not shown) in a manner known per se.

The processing device 300 can be part of the control device 120 of the X-ray inspection apparatus 100, as shown in the FIG. 8b. However, the processing device 300 may also be located separately from the X-ray inspection apparatus 100 adjacent thereto or at a location remote therefrom, for example at a central location where raw detector data from several inspection apparatuses 100 are combined and centrally processed there. The arrangement of the processing device 300 in or at the X-ray inspection apparatus 100 or remote therefrom makes no difference to the proposed measures for processing the detector data.

The processing device 300 can also already be part of the arrangement 10 or of the detector 20. The detector data generated by the detector 20 can then already be processed at the detector 20 in accordance with the measures proposed herein. Thus, the arrangement 10 proposed herein would in principle be compatible with existing X-ray inspection apparatuses with conventional detector units. I.e., in X-ray inspection systems which are other-wise sufficiently identical in construction, an implementation of the new arrangement 10 proposed here with integrated processing of the detector data can achieve a constant image quality at lower system costs or, alternatively, the spatial resolution of an existing X-ray inspection apparatus could be increased at virtually constant system costs.

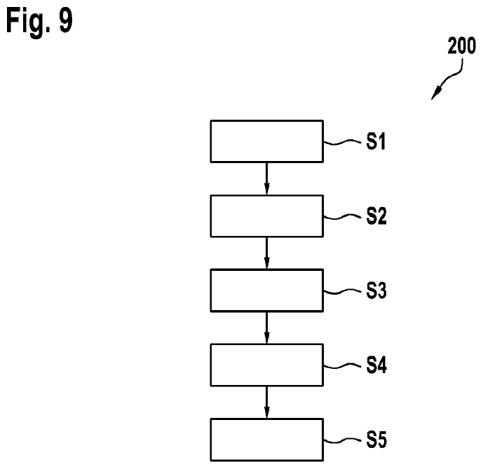

FIG. 9 illustrates the basic structure of a method 200 for increasing the spatial resolution of the X-ray detector 20, which can be used, for example, in the arrangement shown in FIGS. 1a-7b. Thereby, the method 200 includes the following basic steps:

A step S1 for first reading out the detector element 24 at a first point of time t, during which a first area 24′ of the detector element 24 is irradiated by X-rays RX.

A step S2 for second reading out S2 the detector element 24 at a second point of time t+1, during which a second area 24″ of the detector element 24 is irradiated by the X-rays RX.

A step S3 for calculating associated intensity values of the X-rays RX for the first area 24′ and the second area 24″ for the first point of time point t and the second point of time point t+1.

Optionally, the method may further include a step S4 in which the intensity values calculated in the step S3 are subtracted in order to calculate an intensity value for a virtual pixel with a correspondingly small area, thereby further increasing the spatial resolution of the detector as a result. For this purpose, in the optional step S4, the virtual intensity value of the X-ray radiation RX of a partial area 24″ of the at least one detector element 24 is calculated based on the performed subtraction, whereby the virtual intensity value in the result provides a detector dimension for a correspondingly smaller virtual detector element, thus achieving a further increase in the spatial resolution of the detector.

1. An arrangement of an X-ray detector and a shielding element shielding X-rays (RX) for providing detector data with a higher spatial resolution than the physical resolution of the X-ray detector, wherein the X-ray detector comprises at least one detector line with at least one detector element arranged along the detector line,
the shielding element comprises at least one region opaque for X-rays (RX) and at least one region transparent for X-rays (RX),
the shielding element is arranged in front of the receiving surface of the at least one detector element in the beam direction of the X-rays (RX), and
the shielding element and the at least one detector element are movable relative to one another for a relative movement (RB), so that the effective receiving surface for X-rays (RX) of the at least one detector element can be changed dynamically accordingly.

2. The arrangement according to claim 1, wherein the region of the shielding element which is transparent for X-rays (RX) is a recess.

3. The arrangement according to claim 1, wherein
the region of the shielding element which is transparent for X-rays (RX) is made of a material with a low attenuation for X-rays (RX);
and/or the region of the shielding element which is opaque to X-rays (RX) is made of a material with a high attenuation for X-rays (RX);
wherein the transmittance for X-rays (RX) is higher in the transparent region than in the opaque region.

4. The arrangement according to claim 1, wherein
the shielding element has the form of a comb, a disc, a belt, a wheel, or a tube comprising the detector line; and/or
the shielding element is movable by rotation, translation or by a combination of rotation and translation for the relative movement (RB) to the detector elements.

5. The arrangement according to claim 1, wherein the shielding element is movable by an oscillating movement between a first position and a second position for the relative movement (RB) relative to the detector elements.

6. The arrangement according to claim 1, wherein the region transparent for X-rays (RX) has a stepped profile such that when the shielding element and the at least one detector element are moved relative to each other for relative movement (RB), the effective X-ray (RX) receiving area of the at least one detector element is correspondingly variable in regular or irregular steps.

7. The arrangement according to claim 1, wherein the shielding element is coupled to a first actuator and/or the detector line is coupled to a second actuator, the first actuator and/or the second actuator being controllable for the relative movement (RB) between the shielding element and the at least one detector element.

8. An X-ray inspection apparatus comprising an arrangement according to claim 1, wherein
the X-ray inspection apparatus is configured for transporting an inspection object in a transport direction (TD) through the inspection apparatus and the detector line of the X-ray detector is arranged in a line direction, which is directed orthogonal to the transport direction (TD), and
the X-ray inspection apparatus is configured to provide detected intensity values of the X-rays (RX) from a scanned area of the changed effective receiving area for the X-rays (RX) of the at least one detector element for different points in time.

9. A method for increasing the spatial resolution of an X-ray detector with at least one detector line with at least one detector element, wherein the at least one detector element and a shielding element arranged above the receiving surface for the X-rays (RX) of the at least one detector element are movable relative to one another for a relative movement (RB), whereby the effective receiving surface for the X-rays (RX) of the at least one detector element is changed.

10. The method according to claim 9, wherein the method (200) comprises:
a step S1 with first reading of the at least one detector element at a first point of time t, during which a first area of the at least one detector element is irradiated by the X-rays (RX):
a step S2 with second reading of the at least one detector element at a second point of time t+1, during which a second region of the at least one detector element is irradiated by the X-rays (RX); and
a step S3 with calculation of associated intensity values of the X-rays (RX) for the first region and the second region for the first point of time t and the second point of time t+1.

11. The method according to claim 10, the method further comprising:
a step S4 comprising subtracting (S4) the intensity values calculated in step (S3): and
a step S5 comprising determining (S5) a virtual intensity value of the X-ray radiation (RX) of a partial area of the at least one detector element (24) based on the subtraction in step S3.

12. The method according to claim 11, wherein
the second area of the at least one detector element irradiated by X-rays (RX) overlaps at least a partial area of said first area of said at least one detector element irradiated by X-rays (RX).

13. The method according to claim 10, wherein a change in the relative arrangement of the shielding element and the at least one detector element is synchronized with the respective irradiation of the X-ray detector with X-rays (RX).

14. A processing device for processing the intensity values of the X-rays (RX) provided by the X-ray inspection apparatus according to claim 8.

15. A system comprising an X-ray inspection apparatus according to claim 8 and a processing device, wherein the X-ray inspection apparatus is configured to provide the intensity values based on scanning an inspection object to the processing device and is connected to the processing device for data communication therefor.
